(19) United States
(12) Patent Application Publication
(10) Pub. No.: US 2009/0170477 A1
(43) Pub. Date: Jul. 2, 2009

(54) METHOD TO MASK CELL IDENTIFIERS OR LOCATION AREA CODES OF A MOBILE NETWORK WITH RESPECT TO A MOBILE TERMINAL

(75) Inventors: Michael Bensimon, Grenoble (FR); Eric Lebomin, Biviers (FR); Christophe Giraud-Sauveur, Montbonnot Saint Martin (FR); Nicolas Prunel, Barraux (FR)

Correspondence Address: PERMAN & GREEN, 425 POST ROAD, FAIRFIELD, CT, 06824, US

(73) Assignee: SOCIETE FRANCAISE DE RADIOTELEPHONE, Paris (FR)

(21) Appl. No.: 12/326,966

(22) Filed: Dec. 3, 2008

(30) Foreign Application Priority Data
Dec. 31, 2007 (FR) 07 09180

(51) Int. Cl. H04W 12/06

(52) U.S. Cl. 455/411

(57) ABSTRACT

A method to mask static cell identifiers or static location area codes of a mobile network a mobile terminal and a masking module integrated in equipment belonging to the architecture of the network under consideration, of generating all or part of dynamic cell identifiers or dynamic location area codes from static identifiers or codes so as to make their geographical conversion impossible for an outside service other than services authenticated by the operator. The disclosed embodiments propose a masking device to mask static identifiers or codes including either a module masking static identifiers or codes, integrated in a BSC for GPS or GPRS or in a RNC for UMTS, or another masking module masking all or part of the static identifiers or codes integrated in network equipment close to the operator's platform.

### BACKGROUND

1. Field

The disclosed embodiments concern the area of telecommunications, and in particular global positioning. The disclosed embodiments propose a method to mask cell identifiers or location area codes of a mobile network with respect to a mobile terminal.

2. Brief Description of Related Developments

New telecommunication services are regularly launched to meet the potential needs of consumers. One of the latest to date is global positioning which allows information to be provided on the geographical position of the user. Global positioning can have numerous applications in areas far removed from each other. A user can use global positioning to find the closest cinema or restaurant, to obtain tourist information on a place being visited. Anxious parents are able to locate their child at any time. Business users can locate their vehicles, track personnel and deliveries and detect any possible problems. For authorities, global positioning can be of great assistance in obtaining information on persons who have been kidnapped or in monitoring movements of suspects.

However, global positioning may give rise to much abuse and prove detrimental to users' private lives. The recourse to information of the type identification of radiofrequency cells, also called “cell ID”, or Location Area Code (LAC) or Routing Area Code (RAC) can be used to locate users without their knowledge and without the operator, at the present time, being able to take any action.

At the current time cell IDs and/or Location Area Codes (LACs or RACs) are “static” on all cells of Base Station Controllers (BSCs) or Radio Network Controllers (RNCs), and by collecting these identifiers or these codes it is possible to know the location of the subscriber or user.

To meet legal obligations for the protection of the private lives of users or subscribers, it is necessary to apply mechanisms which can prevent outside actors from deploying locating solutions based on cell IDs or on location area codes.

### SUMMARY

The purpose of the disclosed embodiments is to eliminate one or more prior art drawbacks, and to propose a method to mask cell identifiers or location area codes of a mobile network with respect to a mobile terminal, to ensure the protection of the private life of the users of said mobile terminal.

To achieve this purpose, the method to mask static cell identifiers or static location area codes of a mobile network is characterized in that it consists, vis-à-vis a mobile terminal, of generating all or part of dynamic cell identifiers or dynamic location area codes by means of a masking module integrated in equipment belonging to the architecture of the network under consideration, from the static cell identifiers or static location area codes, so as to make their conversion into geographical coordinates impossible, or scarcely reliable, by any outside actor or service other than services authenticated by the operator; and

either, at the signalling channel, of generating the static cell identifiers or static location area codes from the dynamic cell identifiers or the dynamic location area codes, sent up through the network by the mobile terminal to the masking module, so as to ensure translation of the static cell identifier or static location area code destined for other equipment of the network under consideration, by means of said masking module,

or of updating, either globally or partially, the other equipment of the network under consideration and of the operator's information system by means of said masking module.

According to another feature, the masking method consists of generating the static cell identifiers or static location area codes, by means of a reverse generating module integrated in another item of equipment of the network under consideration, close to the operator's platform or the partner platform for global positioning services, from the dynamic cell identifiers or dynamic location area codes, sent up through the network by the mobile terminal to the reverse generating module, so as to enable services authenticated by the operator to access to the results of the reverse generating module to estimate the location of the mobile terminal after geographical conversion.

A further purpose is achieved by proposing a device to mask static cell identifiers or static location area codes, which can be used to implement the masking method characterized in that it comprises:

either a masking module to mask static cell identifiers or static location area codes, integrated in a BSC controller (Base Station Controller) for a network of GSM or GPRS type, or a RNC controller (Radio Network Controller) for a network of UMTS type;

or another masking module, masking all or part of the static cell identifiers or static location area codes, integrated in an item of equipment of the network under consideration, close to the operator's platform or the partner platform for global positioning services.

According to another feature, the masking module is intended, vis-à-vis a mobile terminal, to generate dynamic cell identifiers or dynamic location area codes from the static cell identifiers or static location area codes, and also, at the BSC or RNC of the network under consideration, to transpose the dynamic cell identifiers or dynamic location area codes sent up by the mobile terminal through an associated BTS to the BSC or RNC, vis-à-vis the other equipment in the network under consideration and at the signalling channel, into static cell identifiers or static location area codes.

According to another feature, the masking module comprises algorithmic means based on reversible mechanisms applying one or more secrets so as to ensure the generating of dynamic cell identifiers or dynamic location area codes, and the transcoding between the dynamic cell identifiers or dynamic location area codes and the static cell identifiers or static location area codes.

According to another aspect, the masking module is associated with a reverse generating module integrated in an operation and maintenance centre OMC or in an information system of the operator or deported onto a platform of the operator or onto a partner platform for global positioning services of the network under consideration, to generate the static cell identifiers or static location area codes at the data channel, from the dynamic cell identifiers or dynamic location area codes sent up through the network under consideration by the mobile terminal to the reverse generating module, to authorize their solving into geographical coordinates and to locate the mobile terminal.

According to another feature, the reverse generating module comprises algorithmic means that are similar to, but the reverse of, the algorithmic means of the masking module.

According to another feature the other masking module, with respect to a mobile terminal and other equipment of the network under consideration and in particular the operator's platform or the partner platform for global positioning services, is intended to generate dynamic cell identifiers or dynamic location area codes from static cell identifiers and static location area codes particular to the operator's information system, so that conversion into geographical coordinates is scarcely reliable and even impossible, this other masking module also being intended, globally or partially, to update said other equipment of the network under consideration and of the operator's information system.

According to another feature, the other masking module comprises algorithmic means that are non-predictive or based on a mechanism applying one or more secrets to generate the dynamic cell identifiers or dynamic location area codes.

According to another feature, the masking module is associated with a reverse generating module intended to generate static cell identifiers or static location area codes, particular to the operator's information system, from dynamic cell identifiers or dynamic location area codes sent up through the network by the mobile terminal to the reverse generating module, to ensure synchronizing or on-the-fly calculation between the static cell identifiers or static location area codes particular to the operator's information system.

According to another feature, the reverse generating module comprises algorithmic means similar to, but the reverse of, the algorithmic means of the other masking module.

### BRIEF DESCRIPTION OF THE DRAWINGS

The disclosed embodiments will be better understood and other purposes, characteristics, details and advantages will become clearer throughout the explanatory description given below with reference to the appended figures, given as non-limiting examples, in which:

FIG. 1 illustrates the first embodiment of the method to mask cell identifiers in a mobile network of GSM type, relative to a mobile terminal;

FIG. 2 illustrates the second embodiment of the method to mask cell identifiers in a mobile network of GSM type, relative to other equipment of the network under consideration.

The disclosed embodiments consist of integrating a masking module, to mask cell identifiers (cell IDs) or location area codes (LACs or RACs), in equipment belonging to the architecture of a mobile network. The disclosed embodiments are designed to adapt to different cell phone technologies, in particular “GSM” technology (Groupe Spécial Mobile), “GPRS” technology (General Packet Radio Service) and “UMTS” technology (Universal Mobile Telecommunications System).

Before starting the description of the disclosed embodiments, the architecture will first be recalled which allows the connection of a mobile terminal 1 to a network, using different technologies (GSM, GPRS, UMTS), these different architectures being known.

For GSM, the architecture consists of a Base Transceiver Station (BTS) 2 which is in charge of the radio link with the mobile terminal 1. The BTS 2 essentially consists of an element interfacing with its controlling station called a Base Station Controller (BSC) 3, of a transceiver and of an antenna, which form what is known as a cell 10. The BTS 2 is able to activate and deactivate a radiofrequency channel, to digitize the content to be transmitted, to encode/decode, to modulate/demodulate a radiofrequency signal, to control the radio link, to monitor the level and quality of reception, to control transmitting power.

It is to be noted that a location area is a group of cells 10.

The Base Station Controller (BSC) 3 is able to command one or more BTSs 2 and is linked to a Mobile Switching Centre (MSC) 4. The BSC 3 decides on activation/deactivation of a channel towards the mobile terminal 1, on the transmitting power of the BTSs 2 and mobile terminals 1, manages cell changes 10 called “handovers”, and concentrates data flows from the BTSs 2.

The Mobile Switching Centre (MSC) 4 is in charge, within the network, of routing the interconnection with other networks and of coordinating calls. The MSC 4 is in charge of several BSCs 3 and concentrates data flows from these BSCs 3. In addition, each MSC 4 is associated with a database called a VLR (Visitor Location Register) which, for all subscribers present in the territory served by the MSC 4, contains their profile and location area. Another database called an HLR (Home Location Register) is linked with the MSC 4 and contains the profiles and rough locations of network subscribers.

In GPRS, the architecture consists of the Base Transceiver Station (BTS) 2 in charge of the radio link with the mobile terminal 1, of the BSC 3 which is able to command one or more BTSs 1 and is linked to a Serving GPRS Support Node (SGSN) 5 which is a gateway enabling the routing of data in mobile networks of GPRS type.

The SGSN 5 manages the interface with the external packet network via another gateway, the Gateway GPRS Support Node (GGSN) 6 for outgoing calls, and towards the mobile terminal 1 for incoming calls. In addition the SGSN 5 holds information on subscriber identifiers and services utilized, and controls the locating of the mobile terminal 1.

In UMTS, a Radio Network Controller (RNC) 7 is intended to control the BTSs 2, called Node-B 2 in UMTS. The RNC 7 is able to manage the distribution of the radio resource, the digitizing of data before it is sent to the mobile terminal 1 and part of the locating of subscribers or users. The RNC 7 is linked to the SGSN 5 which itself is linked to the GGSN 6.

These networks (GSM, GPRS, UMTS) use channels to transmit binary or analogue data, each channel corresponding to a specific frequency at which the electromagnetic wave is modulated. A distinction is made between data channels and signalling channels, e.g. in non-limiting manner the Broadcast Control Channel (BCCH) which allows the distributing of data characteristic of a cell 10.

An Operation and Maintenance Center/Switch (OMC/S) or an Operation and Maintenance Center/Radio (OMC/R) 8 is linked to the BTSs 2 in technology of “GSM” or “GPRS” type, or to the RNCs 7 in technology of “UMTS” type. This Operation and Maintenance Center (OMC) 8 is a computer center for the local monitoring of network equipment. For example some OMCs 8 will monitor groups of BSCs 3 or RNCs 7 and groups of BTSs 2 in different location areas, and other OMCs 8 will monitor the MSCs 4 and VLRs.

This Operation and Maintenance Centre (OMC) 8 is linked to the operator's information system 9 allowing the storage, structuring and communicating of data in text, image, sound or coded data form. The operator's information system 9 is linked to a platform of the operator or to a partner platform for global positioning services 10.

### DETAILED DESCRIPTION OF THE DISCLOSED EMBODIMENTS

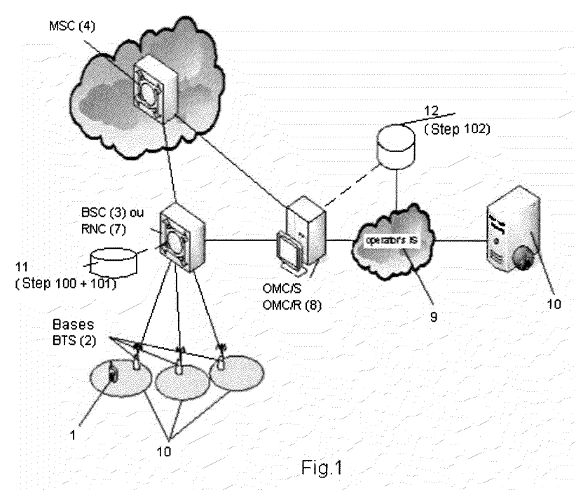

In a first embodiment shown FIG. 1, a masking module 11 masking cell IDs or location area codes (LACs or RACs) is integrated within the BSC 3 in GSM and GPRS, and within the RNC 7 in UMTS. This masking module 11 is intended firstly to generate 100 dynamic cell identifiers (cell ID_d) or dynamic location area codes (LAG_d or RAC_d) i.e. variable in time, with respect to mobile terminals 1, from static cell identifiers (cell ID) or static location area codes (LAC or RAC) so as to make their solving into geographical coordinates impossible by an outside actor or service other than services authenticated by the operator. Also, the masking module 11, at the BSC 3 or RNC 7 of the network under consideration, is intended to transpose 101 the dynamic cell identifiers (cell ID_d) or dynamic location area codes (LAC_d or RAC_d), sent up by the mobile terminal 1 over the air towards a BTS 2 associated with the BSC 3 or RNC 7 then via wire or cable link towards other equipment of the network under consideration, at the signalling channel, into static cell identifiers (cell ID) or static location area codes (LAC or RAC), so as to ensure translation of the static cell identifier (cell ID) or static location area code (LAC or RAC) destined for other equipment in the network under consideration such as the MSC 4, HLR, etc. This transcoding 100, 101 between dynamic cell identifiers (cell ID_d) or dynamic location area codes (LAC_d or RAC_d) and static cell identifiers (cell ID) or static location area codes (LAC or RAC) is achieved using algorithmic means included in the masking module 11. Therefore, only the dynamic cell identifiers (cell ID_d) or dynamic location area codes (LAC_d or RAC_d) can be listened to over the air (OTA).

These algorithmic means conform to the prior art and are based on reversible mechanisms applying one or more secrets which are known to the network equipment authenticated by the operator.

In one example of the first embodiment, the dynamic cell identifiers (cell ID_d) or dynamic location area codes (LAC_d or RAC_d) are generated 100 daily by the masking module 11. This daily generation 100 may relate to date or timestamp used as time reference, in this example the day, and representing the number of seconds elapsed since a reference time and/or a known increment and/or a secret key.

Advantageously, the BSC 3 or RNC 7 acts as proxy i.e. a computer server whose function is to relay requests between the mobile terminal 1 and the BTSs 2 and the other equipment of the network under consideration.

According to the disclosed embodiments, the cell 10 or a location area respectively has two cell identifiers or two location area codes with respect to the BSC 3 of RNC 7. A first cell identifier (cell ID) or location area code (LAC or RAC) is unique and static for the Core network, and a second cell identifier (cell ID_d) or location area code (LAC_d or RAC_d) is dynamic for dialogue with the mobile terminal 1.

Additionally, a reverse generating module 12 associated with the masking module 11 can be integrated in the OMC 8 or in the operator's information system, or it can be deported on the operator's platform or the partner platform for global positioning 10 of the network under consideration. This reverse generating module 12 is intended to generate 102 the static cell identifiers (cell ID) or static location area codes (LAC or RAC), at the data channel, from the dynamic cell identifiers (cell ID_d) or dynamic location area codes (LAC_d or RAC_d), sent up through the network under consideration by the mobile terminal 1, to authorize their solving into geographical coordinates.

Advantageously, when the OMC 8 or the operator's information system 9 or the operator's platform or global positioning platform 10 authenticated by the operator of the network under consideration, has geographically converted the static cell identifiers (cell ID) or static location area codes (LAC or RAC) in relation to the topology of the “GSM” or “GPRS” or even “UMTS” network, it is possible for the operator to know the approximate position of the mobile terminal 1 and therefore to locate the user or subscriber. Algorithmic means, similar to, but the reverse of, the algorithmic means of the masking module 11 and conforming to the prior art are also provided within this reverse generating module 12.

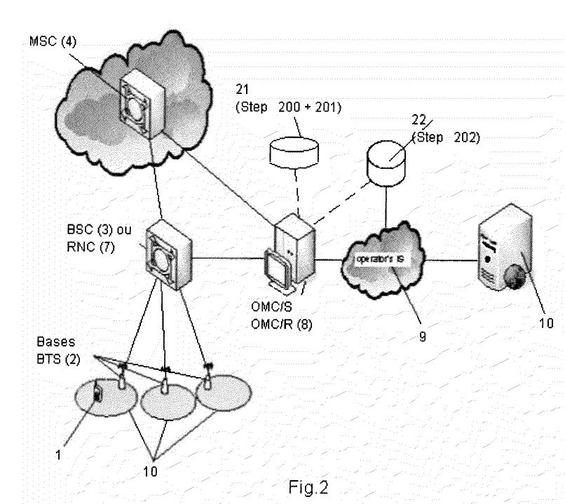

In a second embodiment shown FIG. 2, another masking module 21 masking all or part of the radio cell identifiers (cell ID) or location area codes (LAC or RAC) is integrated in an item of equipment belonging to the architecture of the network under consideration, and close to the operator's platform or partner platform for global positioning services 10. In the illustrated example, this other masking module 21 is included in the OMC 8. This other masking module 21 comprises algorithmic means, optionally non-predictive or based on a mechanism conforming to the prior art applying one or more secrets so that, vis-à-vis the mobile terminal 1 and the other equipment of the network under consideration (MSC 4, BSC 3, HLR, VLR etc.) and notably the operator's platform or partner platform for global positioning services 10, it can generate 200 dynamic radio cell identifiers (cell ID_d) or dynamic location area codes (LAC_d or RAC_d) from static cell identifiers (cell ID) or from static location area codes (LAC or RAC) particular to the operator's information system 9, so that conversion into geographical coordinates is little reliable or even impossible.

In addition, this other masking module 21 in the illustrated example, integrated at the OMC 8, is also intended to update 201, either globally or partially, the other equipment of the network under consideration (MSC 4, BSC 3, HLR, VLR etc.) and of the operator's information system 9.

It is to be noted that it is necessary to modify, synchronously, all the network equipment integrating information on radio cell identifiers (cell ID) or location area codes (LAC or RAC). To do so, a module similar to the other masking module 21 is integrated, for example in each OMC but not limited thereto.

Also, if the operator's information system 9 or an item of network equipment so requires, a reverse generating module 22 generating static cell identifiers (cell ID) or static location area codes (LAC or RAC), particular to the operator's information system 9, from the dynamic cell identifiers (cell ID_d) or from the dynamic location area codes (LAC_d or RAC_d), is integrated in the operator's information system 9 so as to ensure synchronizing or on-the-fly calculation between the static cell identifiers (cell IDs) or static location area codes (LAC or RAC) particular to the operator's information system 9. Algorithmic means, similar to, but the reverse of, the algorithmic means of the other masking module 21 and conforming to the prior art, are also provided within this reverse generating module 22.

In an example of the second embodiment, the dynamic cell identifiers (cell ID_d) or dynamic location area codes (LAC_d or RAC_d) are frequently generated 200 by the other masking module 21. This frequent generation 200 can relate to a known increment and/or a secret key so as to ensure simple reverse generating, performed by the reverse generating module 22, of static cell identifiers (cell ID) or of static location area codes(LAC or RAC) particular to the operator's information system 9 from dynamic cell identifiers (cell ID_d) or from dynamic location area codes (LAC_d or RAC_d), by any item of equipment of the radio network or of the operator's platform or of a partner platform for global positioning services associated with the operator 10.

A description is given below of the method to mask cell identifiers (cell ID) or location area codes (LAC or RAC) of a mobile network with respect to a mobile terminal 1, according to the first embodiment described above.

The method to mask static cell identifiers (cell ID) or static location area codes (LAC or RAC) comprises:

a generation step 100 to generate, vis-à-vis the mobile terminal 1, dynamic cell identifiers (cell ID_d) or dynamic location area codes (LAC_d or RAC_d), by means of the masking module 11 integrated in the BSC 3 for a GSM or GPRS network or in the RNC 7 for a UMTS network, from static cell identifiers (cell ID) or from static location area codes (LAC or RAC), so as to make their solving into geographical coordinates impossible for an outside actor or service other than services authenticated by the operator; and

as soon as signalling data transits on the network under consideration;

a generation step 101, at the signalling channel, to generate static cell identifiers (cell ID) or static location area codes (LAC or RAC), by means of said masking module 11, vis-à-vis other equipment i.e. equipment other than the mobile terminal 1, the BTS 2, BSC 3 or RNC 7 of the network under consideration, from the dynamic cell identifiers (cell ID_d) or dynamic location area codes (LAC_d or RAC_d), so as to ensure translation of the static cell identifier (cell ID) or static location area code (LAC or RAC) intended for this other equipment of the network under consideration.

In addition, the masking method may optionally comprise a generating step 102, at the data channel, to generate static cell identifiers (cell ID) or static location area codes (LAC or RAC), by means of the reverse generating module 12 integrated either in the OMC 8 or in the operator's information system 9 or deported onto the operator's platform or partner platform for global positioning services 10 of the network under consideration, from the dynamic cell identifiers (cell ID_d) or from the dynamic location area codes (LAC_d or RAC_d), sent up through the network by the mobile terminal 1, so as to access the result of the reverse generating module 12 allowing estimation of the position of the mobile terminal 1 after geographical conversion.

A description is given below of the method to mask cell identifiers (cell ID) or location area codes (LAC or RAC) of a mobile network, vis-à-vis a mobile terminal 1, according to the second embodiment described above.

The method to mask cell identifiers (cell ID) or location area codes (LAC or RAC) comprises:

a generation step 200 to generate all or part of dynamic cell identifiers (cell ID_d) or dynamic location area codes (LAC_d or RAC_d), by means of the other masking module 21 integrated in an item of equipment belonging to the architecture of the network under consideration close to the operator's platform or partner platform for global positioning services 10, with respect to the mobile terminal 1 and other equipment of the network under consideration and in particular the operator's platform or partner platform for global positioning services 10 but other than the equipment in which the masking module 21 is integrated, from static cell identifiers (cell ID) or from static location area codes (LAC or RAC) particular to the operator's information system 9 of the network under consideration, so as to make their solving into geographical coordinates scarcely reliable or impossible by an outside actor or service other than services authenticated by the operator; and

an update step 201 updating globally or in part the other equipment of the network under consideration and the operator's information system 9 by means of said other masking module 21.

Additionally, the masking method comprises a generation step 202 to generate static cell identifiers (cell ID) or static location area codes (LAC or RAC) particular to the operator's information system 9, by means of a reverse generating module 22 integrated in the operator's information system 9, from dynamic cell identifiers (cell ID_d) or from dynamic location area codes (LAC_d or RAC_d) so as to ensure the synchronizing or on-the-fly calculation between the static cell identifiers (cell ID) or static location area codes (LAC or RAC) particular to the operator's information system 9. Advantageously, services authenticated by the operator can access the result of the reverse generating module 22 allowing estimation of the location of the mobile terminal 1 after geographical conversion.

One of the advantages of the disclosed embodiments is that the method to mask cell identifiers (cell IDs) or location area codes (LAC or RAC) of a mobile network with respect to a mobile terminal 1, or of a mobile terminal 1 and other equipment in the network under consideration, affords protection of the private lives of users or subscribers.

It will be obvious for persons skilled in the art that the disclosed embodiments allows embodiments in numerous other specific forms without departing from the area of application of the disclosed embodiments such as claimed. Therefore the above embodiments are to be construed as illustrative and can be modified in the area defined by the scope of the appended claims, and the disclosed embodiments are not to be considered as limited to the details given above.

1. A method to mask static cell identifiers (cell IDs) or static location area codes (LAC or RAC) of a mobile network, comprising generating, via a mobile terminal, all or part of dynamic cell identifiers (cell ID_d) or dynamic location area codes (LAC_d or RAC_d), by means of a masking module integrated in equipment belonging to the architecture of the network under consideration, from static cell identifiers (cell ID) or from static location area codes (LAC or RAC) so as to make their solving into geographical coordinates scarcely reliable or impossible by any outside actor or service other than services authenticated by the operator; and
either generating, at the signalling channel, the static cell identifiers (cell ID) or static location area codes (LAC or RAC) from the dynamic cell identifiers (cell ID_d) or dynamic location area codes (LAC_d or RAC_d), sent up through the network by the mobile terminal to the masking module, so as to ensure translation of the static cell identifier (cell ID) or static location area code (LAC or RAC) intended for the other equipment of the network under consideration, by means of said masking module;
or updating, globally or partially the other equipment of the network under consideration and the operator's information system by means of said masking module.

2. The masking method according to claim 1, comprising generating the static cell identifiers (cell ID) or static location area codes (LAC or RAC), by means of a reverse generating module integrated in another item of equipment of the network under consideration, close to the operator's platform or the partner platform for global positioning services, from the dynamic cell identifiers (cell ID_d) or dynamic location area codes (LAC_d or RAC_d), sent up through the network by the mobile terminal to the reverse generating module, so as to allow services authenticated by the operator to access to the results of the reverse generating module allowing estimation of the location of the mobile terminal after geographical conversion.

3. A masking device masking static cell identifiers (cell ID) or static location area codes (LAC or RAC) to allow implementation of a masking method, comprising:
either a masking module to mask static cell identifiers (cell ID) or static location area codes (LAC or RAC), that is integrated in a BSC controller for a network of GSM or GPRS type, or in a RNC controller for a network of UMTS type;
or another masking module to mask all or part of static cell identifiers (cell ID) or static location area codes (LAC or RAC), integrated in an item of equipment of the network under consideration close to the operator's platform or partner platform for global positioning services.

4. The masking device according to claim 3, wherein the masking module is intended, via a mobile terminal, to generate dynamic cell identifiers (cell ID_d) or dynamic location area codes (LAC_d or RAC_d) from static cell identifiers (cell ID) or from static location area codes (LAC or RAC) and, at the BSC or RNC of the network under consideration, to transpose the dynamic cell identifiers (cell ID_d) or dynamic location area codes (LAC_d or RAC_d) sent up by the mobile terminal through an associated BTS to the BSC or RNC, vis-à-vis the other equipment in the network under consideration and at the signalling channel, into static cell identifiers (cell ID) or static location area codes (LAC or RAC).

5. The masking device according to claim 3, wherein the masking module comprises algorithmic means based on reversible mechanisms applying one or more secrets so as to ensure the generating of dynamic cell identifiers (cell ID_d) or dynamic location area codes (LAC_d or RAC_d) and the transcoding between the dynamic cell identifiers (cell ID_d) or dynamic location area codes (LAC_d or RAC_d) and the static cell identifiers (cell ID) or static location area codes (LAC or RAC).

6. The masking device according to claim 3, wherein the masking module is associated with a reverse generating module integrated in an Operation and Maintenance Centre OMC or in the operators' information system or deported onto the operator's platform or a partner platform for global positioning service of the network under consideration, to generate the static cell identifiers (cell ID) or static location area codes (LAC or RAC), at the data channel, from the dynamic cell identifiers (cell ID_d) or from the dynamic location area codes (LAC_d or RAC_d), sent up through the network under consideration by the mobile terminal to the reverse generating module, to authorize their solving into geographical coordinates and to locate the mobile terminal.

7. The masking device according to claim 6, wherein the reverse generating module comprises algorithmic means similar to, but the reverse of, the algorithmic means of the masking module.

8. The masking device according to claim 3, wherein the other masking module is intended, vis-à-vis a mobile terminal and other equipment of the network under consideration notably the operator's platform or the partner platform for global positioning services, to generate dynamic cell identifiers (cell ID_d) or dynamic location area codes (LAC_d or RAC_d) from static cell identifiers (cell ID) and static location area codes (LAC or RAC) particular to the operator's information system so that solving into geographical coordinates is scarcely reliable even impossible, this other masking module also being intended to update, globally or partially, said other equipment of the network under consideration and of the operator's information system.

9. The masking device according to claim 8, wherein the other masking module comprises algorithmic means that are non-predictive or based on a mechanism applying one or more secrets to generate the dynamic cell identifiers (cell ID_d) or dynamic location area codes (LAC_d or RAC_d).

10. The masking device according to claim 8, wherein the masking module is associated with a reverse generating module intended to generate static cell identifiers (cell ID) or static location area codes (LAC or RAC), particular to the operator's information system, from dynamic cell identifiers (cell ID_d) or dynamic location area codes (LAC_d or RAC_d), sent up through the network by the mobile terminal to the reverse generating module, to ensure synchronizing or on-the-fly calculation between the static cell identifiers (cell ID) or static location area codes (LAC or RAC) particular to the operator's information system.

11. The masking device according to claim 10, wherein the reverse generating module comprises algorithmic means similar to, but the reverse of, the algorithmic means of the other masking module.
